(19) United States
(12) Patent Application Publication
(10) Pub. No.: US 2005/0120558 A1
(43) Pub. Date: Jun. 9, 2005

(54) Method Of Producing A Bearing Housing From A Worn Housing, And Fixture Implementing Such A Method

(75) Inventor: Maurizio D'Ambra, Forio (IT)

Correspondence Address: HOWREY SIMON ARNOLD AND WHITE LLP, 750 BERING DRIVE, HOUSTON, TX, 77057, US

(73) Assignee: AVIO S.p.A., Rivalta di Torino (IT)

(21) Appl. No.: 10/604,029

(22) Filed: Jun. 23, 2003

(30) Foreign Application Priority Data
Jul. 5, 2002 (IT) TO2002A 000590

(51) Int. Cl. B23P 6/00; B23P 19/04

(52) U.S. Cl. 29/898.01; 29/402.03; 29/402.08; 29/402.09; 29/402.11

(57) ABSTRACT

14A method of producing a bearing housing from a worn housing extending along an axis and having an intermediate portion; four end portions located at opposite axial ends of the intermediate portion; and an inner shield, the ends of which are integral with the intermediate portion and one end portion. According to the method, the intermediate portion and the shield are detached from the end portions and replaced with a new shield and a new intermediate portion, whereas the end portions are used again; and, to weld the new intermediate portion to the salvaged end portions, a fixture is provided for ensuring the necessary parallelism, squareness, flatness, concentricity, and dimensions of the portions.

### BACKGROUND

The present invention relates to a method of producing a bearing housing from a worn housing, and in particular a housing normally used in aircraft turbines and of the type comprising a casing, and a shield fitted integrally inside the casing as a heat shield.

The in-service stress to which the housing is subjected results in the formation of cracks in the shield and, above all, in the weld areas between the shield and casing.

To prevent damage caused by such cracks, the worn housing is replaced by a housing comprising practically all new component parts, and which involves considerable time and cost to produce and substitute.

### SUMMARY

It is an object of the present invention to provide a method of producing a bearing housing from a worn housing, and which provides a straightforward, low-cost solution to the aforementioned problems.

According to the present invention, there is provided a method of producing a bearing housing from a worn housing extending along an axis and comprising a used intermediate portion; a first and a second used front portions aligned with said used intermediate portion; a first and a second used rear portions also aligned with said used intermediate portion; and a used shield inside said used intermediate, front and rear portions, and the ends of which are integral with said used intermediate portion and said first used front portion respectively; characterized by comprising the steps of detaching said used shield from said first used front portion and from said used intermediate portion; detaching said used intermediate portion from said first used rear portion and from said second used front portion; and connecting a new shield integrally to a new intermediate portion and to said first used front portion.

The present invention also relates to a fixture for producing a bearing housing from a worn housing, and which provides for achieving parallelism, squareness, flatness, roundness, and flat surface and diameter dimensions within tolerances of a hundredth of a millimeter.

### BRIEF DESCRIPTION OF DRAWINGS

A non-limiting embodiment of the invention will be described by way of example with reference to the accompanying drawings, in which:

FIGS. 1 to 8 show a number of steps in a preferred embodiment of the method for producing a bearing housing from a worn housing according to the present invention;

FIG. 9 shows a plan view of a fixture for producing a bearing housing in accordance with the method shown in FIGS. 1 to 8;

FIG. 10 shows a larger-scale section of the FIG. 9 fixture along line X-X in FIG. 9.

### DETAILED DESCRIPTION

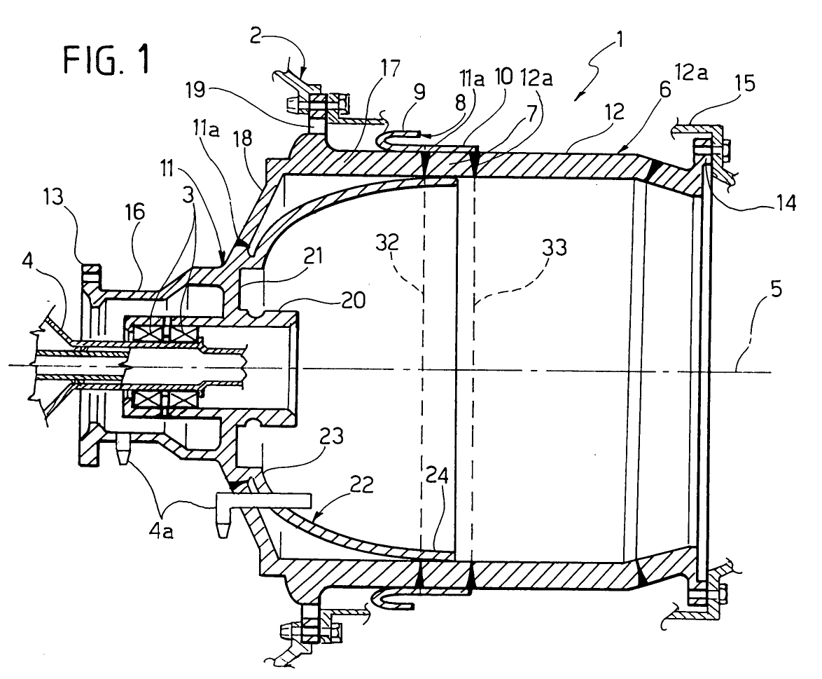

Number 1 in FIG. 1 indicates a bearing housing fitted, in use, to a turbine 2 of an aircraft engine (shown partly and schematically) and commonly referred to as “nÂ°4 bearing housing”.

Housing 1 is bolted (in a manner not shown in detail) to a diffuser 15 of the aircraft engine, and houses a double ball bearing 3 (shown schematically) supporting for rotation a hollow shaft 4 of the aircraft engine compressor rear hub. Housing 1 is fitted with three oil drain fittings or pipes 4a (only two shown), and with a two-stage oil recovery pump (not shown), which is bolted (in a manner not shown) to the front of housing 1 and driven by the compressor to recover oil from housing 1 and the so-called “nÂ°5 bearing housing”, and expel the recovered oil from the engine.

The terms “front” and “rear” used here and hereinafter refer to the gas flow direction of the turbine, and indicate the parts on the left and right respectively in FIGS. 1 to 8.

Housing 1 extends along an axis 5, is coaxial with shaft 4 in use, and comprises a tubular casing 6 terminating axially with a front connecting flange 13 and a rear connecting flange 14.

Still with reference to FIG. 1, casing 6 comprises an intermediate axial portion 7 fitted on the outside with a locating ring 8 having a free C-section appendix 9, and a tab 10 welded to the outer surface of portion 7.

Casing 6 also comprises two portions 11, 12 located at opposite axial ends of portion 7. Portion 12 is substantially cylindrical, and is interposed between and connected to portion 7 and flange 14 by welds 12a shown schematically; while portion 11 is actually defined by two portions 16, 17 welded to each other and to portion 7 by electron beam welds (EBW) 11a shown schematically.

Portion 17 is substantially cylindrical, defines an axial extension of portions 7 and 12, is welded at the rear to portion 7, and has an outer flange 19 connected, in use, to the engine structure.

Portion 17 terminates at the front with a substantially truncated-cone-shaped portion 18, from which portion 16 extends axially.

Portion 16 terminates with flange 13, and is fitted inside with a projecting cylindrical sleeve 20, which houses and supports bearing 3 and is made integral with portion 16 by an intermediate radial ring 21.

Housing 1 also comprises a wall or shield 22, which acts as a heat shield, is housed inside casing 6, facing portions 17, 18, and is connected at the ends 23, 24 to portion 18 and portion 7 respectively.

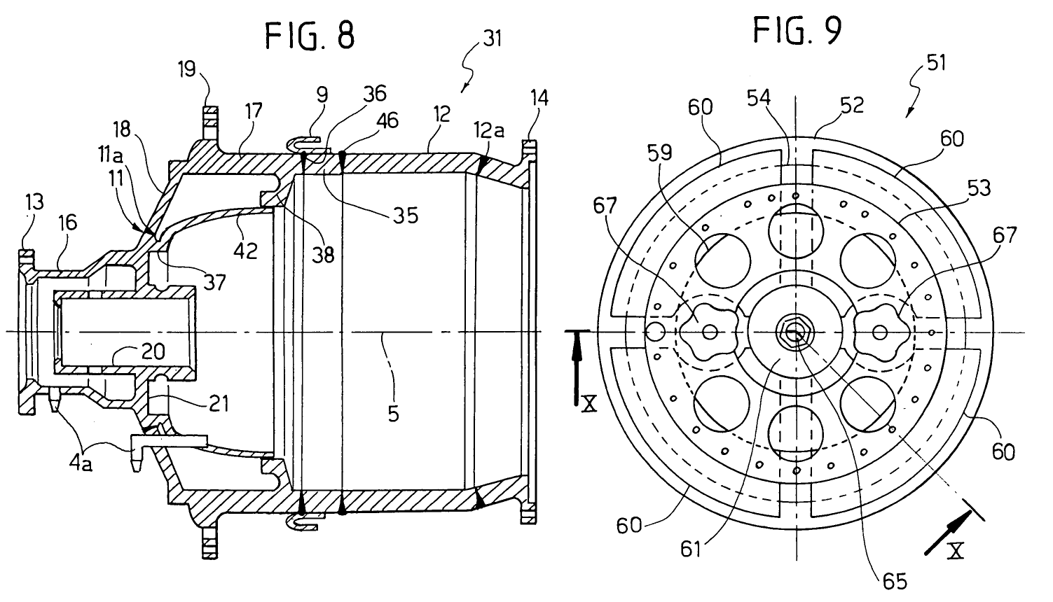

Housing 1 is subject, in use, to the formation of cracks, particularly at the joins between shield 22 and portion 7, so a process is implemented to salvage part of housing 1 with which to produce a reusable housing 31 (FIG. 8). With reference to FIG. 1, according to said process, portion 7 is detached from portions 12 and 17 by two cutting operations along parallel ideal surfaces 32, 33. The cut along surface 32 also removes end 24 of shield 22 and the end of ring 8, which remain welded to portion 7; and the rest of shield 22 is then detached from portion 18 by a further cutting operation at end 23.

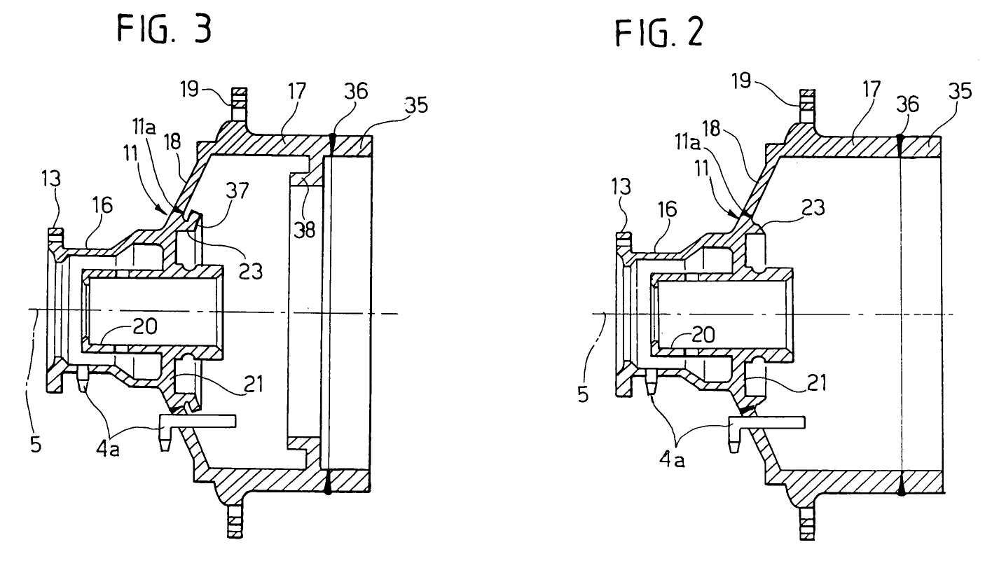

With reference to FIGS. 2 and 3, after sandblasting the inner surface of portion 17 and cleaning portion 18 with hydrochloric acid and pressurized water, portion 7 is replaced with a new portion 35, which is aligned with portion 17 and then connected to portion 17 by a “TIG” weld 36 (shown schematically).

Two fastening appendixes 37, 38 are then formed on portion 11 by TIG welding and from weld metal. Appendixes 37, 38 are L-shaped, are welded to and project from respective portions 18 and 17, and are located facing each other adjacent to portion 35.

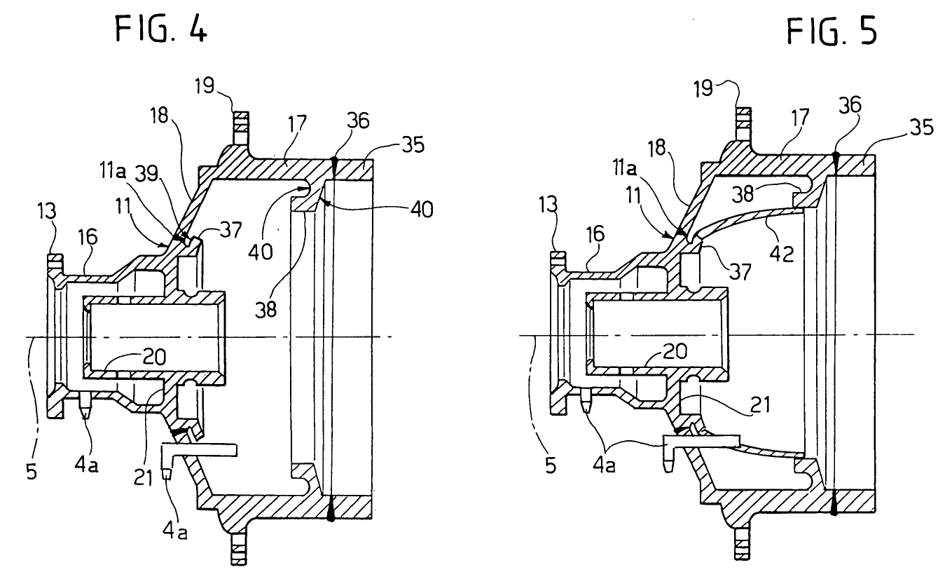

As shown in FIG. 4, after stress relieving, appendixes 37, 38 are machined to form bevels and/or fillets (not dimensioned or described in detail) on surfaces 39, 40, which is followed by shotblasting the inner surface of portions 17, 18.

As shown in FIG. 5, a new shield 42 is welded to appendixes 37, 38, is located closer to axis 5 than former shield 22, and in which three relief holes (not shown) are formed.

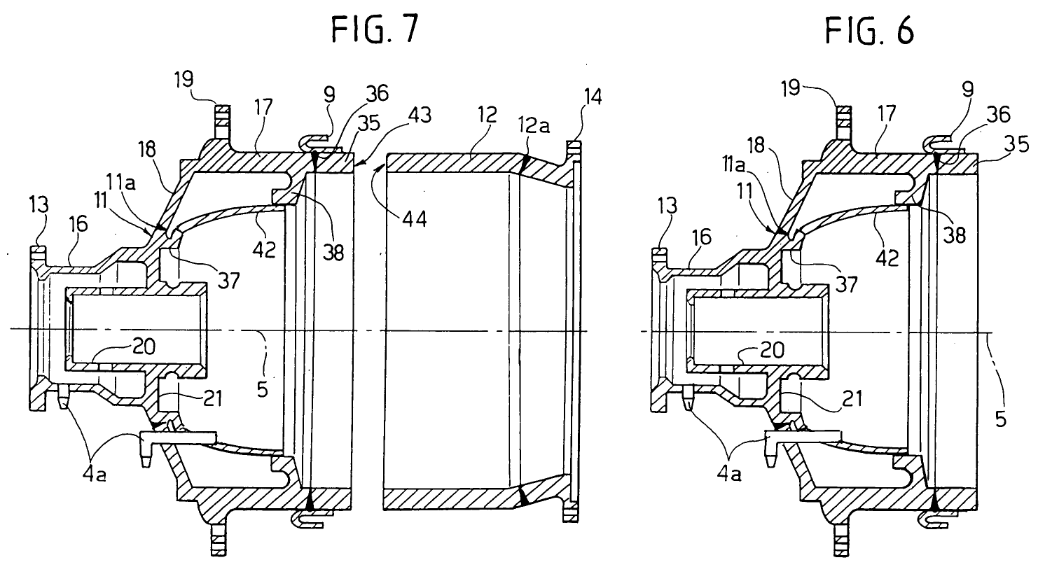

With reference to FIG. 6, after further stress relieving, appendix 9 is changed and resistance welded integrally to the outer surface of portion 35.

As shown in FIG. 7, portion 12 is recovered, and end surfaces 43 and 44 of respective portions 35 and 12 are machined to obtain the required total axial length of housing 31 measured between flanges 13 and 14.

As shown in FIG. 8, after aligning and mating surfaces 43 and 44, portions 12 and 35 are connected integrally to each other by a weld 46 (shown schematically).

At the end of the process, a full dimensional check of housing 31 is made; and, at the end of each welding operation, visual inspection is made of the relative positions of the welded components, and fluorescent penetrant testing is conducted to reveal any cracks or porosity.

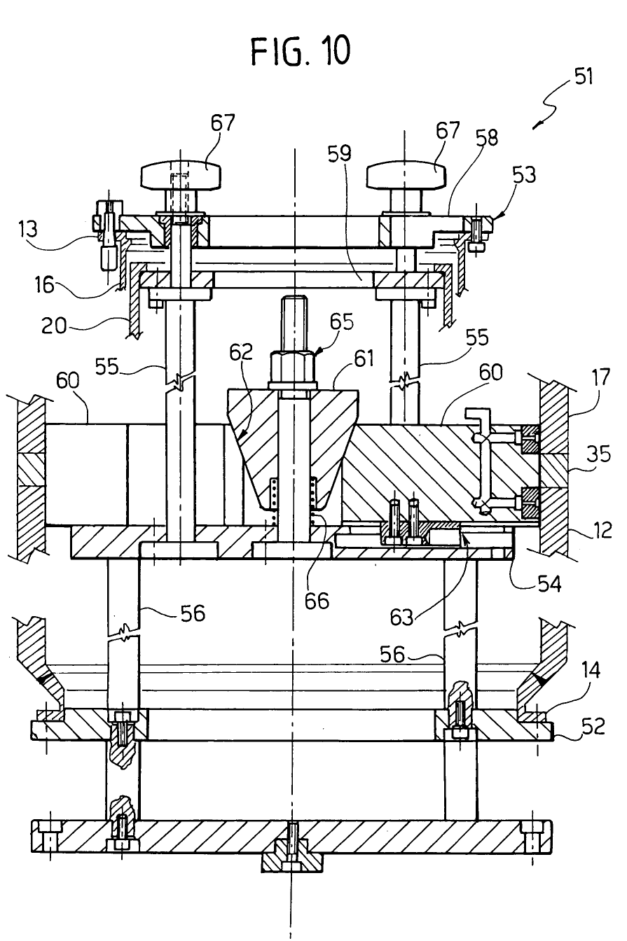

As stated, portions 35, 11, 12 are only welded after aligning portions 35, 11, 12, flanges 13, 14, and sleeve 20 with one another along axis 5 using a fixture 51 shown in FIGS. 9, 10.

Fixture 51 comprises a base 52, which is connected to flange 14 and centred with respect to axis 5; a head 53, which is connected to flange 13; and a disk 54 connected integrally to head 53 and base 52 by respective pairs of columns 55, 56.

Head 53 comprises a top cover 58; and a locating and supporting disk 59, which is interposed axially between cover 58 and disk 54, is connected integrally to columns 55, and centres sleeve 20 with respect to axis 5.

Disk 54 is fitted with four sectors 60, which face disk 59, are angularly spaced about axis 5, are arranged about a central truncated-cone-shaped wedge 61, and have respective conical surfaces 62 converging towards base 52 and mating in sliding manner with the lateral surface of wedge 61.

Sectors 60 are connected to disk 54 by respective guide-and-slide connecting devices 63 enabling sectors 60 to slide radially outwards to align portions 12 and 17 when wedge 61 moves down axially towards disk 54. The downward movement of wedge 61 is controlled by a screw-nut screw device 65 in opposition to the elastic action of a spring 66 interposed axially between wedge 61 and disk 54.

With reference to FIG. 10, in actual use, portions 12, 35 and 17 (shown schematically and partly with respect to FIGS. 1 to 8) are positioned on fixture 51 by fitting portions 12, 35 and 17 about sectors 60, fixing flange 14 to base 52 by means of bolts, and resting the end flange 20a of sleeve 20 on disk 59.

Cover 58 is then connected to flange 13 by means of further bolts, and is locked to columns 55 by means of two knobs 67 screwed to the ends of columns 55. Working device 65 through an axial hole in cover 58 and disk 59, wedge 61 is then pushed downwards to part sectors 60 radially by equal amounts, so that the inner surfaces of portions 17, 35 and 12 are forced radially outwards to mate the surfaces for welding perfectly.

Fixture 51 therefore provides for controlling weld distortion and shrinkage to obtain the required flatness, roundness, parallelism, squareness and dimensions of housing 31.

Moreover, the method described and illustrated obviously provides for producing a housing 31 from a worn housing 1 using several salvaged parts of housing 1 itself, thus eliminating the need for new spare parts, and so saving time and money.

In fact, only portion 7, shield 22 and ring 8 are replaced, whereas the known art involves replacing at least components 18, 8, 7, 12, 22, electron beam welding (EBW), highly complex turning, milling and reaming operations, profile reconstructions, and numerous drilling operations and adjustments.

In the method according to the present invention, on the other hand, all the components, with the exception of 7, 22 and 8, are used again, after being cleaned, for example, and are welded to the new components, with appropriate checks and stress relieving to ensure maximum weld quality.

The method is relatively straightforward, by involving only one cutting operation to detach portion 7 from portion 11, appendix 9 and shield 22. Moreover, appendixes 37, 38 enable shield 42 to be connected easily to, and at a distance from the inner surface of, portion 11.

Clearly, changes may be made to the method as described herein without, however, departing from the scope of the present invention.

In particular, the sequence of some of the steps described may be other than as indicated by way of example, and/or portion 12 need not be salvaged entirely.

1) A method of producing a bearing housing (31) from a worn housing (1) extending along an axis (5) and comprising a used intermediate portion (7); a first (16) and a second (17) used front portions aligned with said used intermediate portion (7); a first (12) and a second (14) used rear portions also aligned with said used intermediate portion (7); and a used shield (22) inside said used intermediate, front and rear portions (7, 16, 17, 12, 14), and the ends (24, 23) of which are integral with said used intermediate portion (7) and said first used front portion (16) respectively; characterized by comprising the steps of detaching said used shield (22) from said first used front portion (16) and from said used intermediate portion (7); detaching said used intermediate portion (7) from said first used rear portion (12) and from said second used front portion 17); and connecting a new shield (42) integrally to a new intermediate portion (35) and to said first used front portion (16).

2) A method as claimed in claim 1, characterized in that the step of detaching said used shield (22) from said used intermediate portion (7), and the step of detaching said used intermediate portion (7) from said second used front portion (17) are performed by means of a single cutting operation (32).

3) A method as claimed in claim 1, characterized in that connecting said new shield (42) to said first used front portion (16) comprises the operations of connecting two projecting fastening appendixes (37, 38) integrally to the inside of said first and, respectively, second used front portions (16, 17); and welding said new shield (42) to said fastening appendixes (37, 38).

4) A method as claimed in claim 3, characterized in that said fastening appendixes (37, 38) are connected by forming the fastening appendixes from weld material.

5) A method as claimed in claim 3, characterized by comprising a stress relieving operation, and a shotblasting operation on the inner surface of said second used front portion (17) after said fastening appendixes (37, 38) are connected.

6) A method as claimed in claim 3, characterized by comprising the further step of finishing at least part of the lateral surfaces (39, 40) of said fastening appendixes (37, 38) prior to welding said new shield (42).

7) A method as claimed in claim 6, characterized by comprising a further stress relieving operation after said new shield (42) is welded to said fastening appendixes (37, 38).

8) A method as claimed in claim 3, characterized by comprising the further steps of sandblasting and cleaning the inner surface of said second used front portion (17) prior to connecting said fastening appendixes (37, 38).

9) A method as claimed in claim 1, characterized by comprising the further step of recovering said first used rear portion (12), and connecting said first used rear portion (12) and said new intermediate portion (35) integrally to each other.

10) A method as claimed in claim 9, characterized in that said first used rear portion (12) and said new intermediate portion (35) are connected to each other by aligning said first used rear portion (12) and said new intermediate portion (35) axially with each other.

11) A method as claimed in claim 10, characterized by finishing the end surfaces (43, 44), to be mated axially during alignment, of said new intermediate portion (35) and said first used rear portion (12).

12) A fixture (51) for producing a bearing housing (31) from a worn housing (1) in accordance with the method claimed in claim 10, characterized by comprising a base (52), which is fixed to an end portion (14) of said housing (31); radial forcing means (60) coaxial with said base (52); and actuating means (61, 65) for pushing said forcing means (60) radially against an intermediate portion (35) of said housing (31), so as to keep said intermediate portion (35) aligned axially with said end portion (14) when connecting the intermediate portion (35) and the first used rear portion (12).

13) A fixture as claimed in claim 12, characterized by comprising a head (53) coaxial with said base (52) and said forcing means (60), and which is fixed to a further end portion (13) of said housing (31); said forcing means (60) being interposed axially between said base (52) and said head (53) to keep said end portions (13, 14) and said intermediate portion (35) axially aligned simultaneously.

14) A fixture as claimed in claim 12, characterized in that said actuating means (61, 65) comprise wedge means (61) movable axially and cooperating with said forcing means (60) to push the forcing means (60) radially.

15) A fixture as claimed in claim 12, characterized in that said forcing means (60) comprise a number of angularly spaced sectors (60); supporting means (54) and guide-and-slide means (63), interposed between said supporting means (54) and each of said sectors (60), being provided to guide said sectors (60) radially.
